(19) United States
(12) Patent Application Publication
(10) Pub. No.: US 2006/0022802 A1
(43) Pub. Date: Feb. 2, 2006

(54) Radio frequency identification-based power management system and method for wireless communication devices

(76) Inventor: Raj Bridgelall, Morgan Hill, CA (US)

Correspondence Address: INGRASSIA FISHER & LORENZ, P.C., 7150 E. CAMELBACK, STE. 325, SCOTTSDALE, AZ, 85251, US

(21) Appl. No.: 10/909,960

(22) Filed: Jul. 30, 2004

(51) Int. Cl. H04Q 5/22

(52) U.S. Cl. 340/10.33; 710/73

(57) ABSTRACT

A wireless communication system implements various RFID-based methods for wireless communication devices and wireless network infrastructures. The communication system includes an RFID tag and a wireless communication device. The RFID tag is configured to receive an RFID interrogation signal and, upon receipt thereof, to supply one or more transition signals. The wireless communication device is configured to operate in a plurality of operational states, is coupled to receive the transition signals, and is configured, upon receipt thereof, to transition from at least a first operational state to a second operational state.

### TECHNICAL FIELD

This invention relates to the field of radio frequency identification (RFID) and, more particularly, to various RFID-based systems and methods for wireless communication devices and wireless network infrastructures.

### BACKGROUND

Communication via wireless media is becoming increasingly popular, and its usage is in numerous and varied business environments also continues to increasing. A major reason for its increased popularity and usage is that computers and other communication devices are no longer encumbered by wired network connections, which can substantially inhibit, if not totally prevent, device mobility. Instead, devices with wireless communication capabilities users of such devices may freely move about and access one or more communication networks.

It logically follows that, to implement complete wireless capability, a device should include a stand-alone power source so that it is not continuously connected to a fixed, external power source via a wired connection. Thus, many wireless communication devices are powered, or are capable of being powered, by a rechargeable power source, such as one or more rechargeable batteries. Typically, the rechargeable power source is charged by connecting it to a fixed, external power source. Once the rechargeable power is sufficiently charged, the device may be disconnected from the external power source, and used to implement full wireless communication with, for example, a wireless local area network (WLAN).

Many wireless devices include power management systems and/or methods conserve the power stored in the rechargeable power source when the wireless device is disconnected from the external power source. For example, many wireless devices are configured to go into a “low-power” or “sleep” mode after a period of non-use. In the sleep mode many of the device internal circuits are not drawing power from the mobile device power source. In many instances, the wireless device is further configured to periodically “wake up,” or exit the sleep mode, and to poll or query the WLAN to determine whether the WLAN wants to communicate with the wireless device. These periodic “waking up” and polling operations can significantly deplete the rechargeable power source. This in turn can reduce the amount of time that the wireless device can continue complete wireless operations, can increase the recharge frequency of the rechargeable power source, and can reduce the overall lifetime of the rechargeable power source.

Hence, there is a need for a system and method of power management of wireless communication devices that improvise on one or more of the above-noted drawbacks. Namely, a system and method that increases the amount of time that a wireless device can continue complete wireless operations, and/or decreases the recharge frequency of wireless device rechargeable power sources, and/or increases the overall lifetime of wireless device rechargeable power sources. The present invention addresses one or more of these drawbacks.

### BRIEF SUMMARY

The present invention provides RFID-based systems and methods for wireless communication devices and wireless network infrastructures that, among other things, improve on presently known power management methods, provide selective software routine launching capabilities by the wireless communication devices, and provide enhanced device and network security features.

In one embodiment, and by way of example only, a wireless device includes an RFID tag and a wake-up circuit. The RFID tag is configured to receive an RFID interrogation signal and, upon receipt thereof, to supply one or more transition signals. The wake-up circuit is coupled to receive the transition signals and is configured, upon receipt thereof, to transition the wireless device from a first operational state to a second operational state.

In another exemplary embodiment, a wireless communication system includes an RFID tag and a wireless communication device. The RFID tag is configured to receive an RFID interrogation signal and, upon receipt thereof, to supply at least a transition signal. The wireless communication device is configured to operate in a plurality of operational states, is coupled to receive the transition signal, and is configured, upon receipt thereof, to transition from at least a first operational state to a second operational state.

In yet another exemplary embodiment, a system for controlling the operational state of a wireless device includes an RFID transceiver and an RFID tag. The RFID transceiver is configured to at least transmit an RFID interrogation signal. The RFID tag is configured to receive the RFID interrogation signal and, in response thereto, to at least transmit a transition signal that, upon receipt thereof by the wireless device, transitions the wireless device from a first operational state to a second operational state.

In still a further exemplary embodiment, a method of managing the operation of a wireless communication device having an RFID tag in operable communication therewith includes the steps of transmitting an RFID interrogation signal to the RFID tag and, upon receipt of the RFID interrogation signal, transitioning the wireless communication device from a first operational state to a second operation state.

Other independent features and advantages of the preferred system and method will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing figures, wherein like numerals denote like elements, and wherein:

FIG. 1 is a functional block diagram of a wireless communication system according to an exemplary embodiment of the present invention;

FIG. 2 is a simplified representation of a wireless communication network that includes the system of FIG. 1;

FIG. 3 is a functional block diagram of an exemplary embodiment of an access point that may be used in the system and network of FIGS. 1 and 2, respectively;

FIG. 4 is a functional block diagram of an exemplary embodiment of mobile unit that may be used in the system and network of FIGS. 1 and 2, respectively;

FIG. 5 is a functional block diagram of an exemplary embodiment of an RFID tag that may be used with the mobile device of FIG. 4;

FIG. 6 is a flowchart depicting an exemplary embodiment of a power management process that may be implemented by the system and network of FIGS. 1 and 2, respectively;

FIG. 7 is a flowchart depicting an exemplary embodiment of an application launching process that may be implemented by the system and network of FIGS. 1 and 2, respectively; and

FIG. 8 is a flowchart depicting an exemplary embodiment of a location-based application launching process that may be implemented by the system and network of FIGS. 1 and 2, respectively.

### DETAILED DESCRIPTION OF A PREFERRED EMBODIMENT

The following detailed description is merely exemplary in nature and is not intended to limit the invention or the application and uses of the invention. Furthermore, there is no intention to be bound by any expressed or implied theory presented in the preceding technical field, background, brief summary, or the following detailed description.

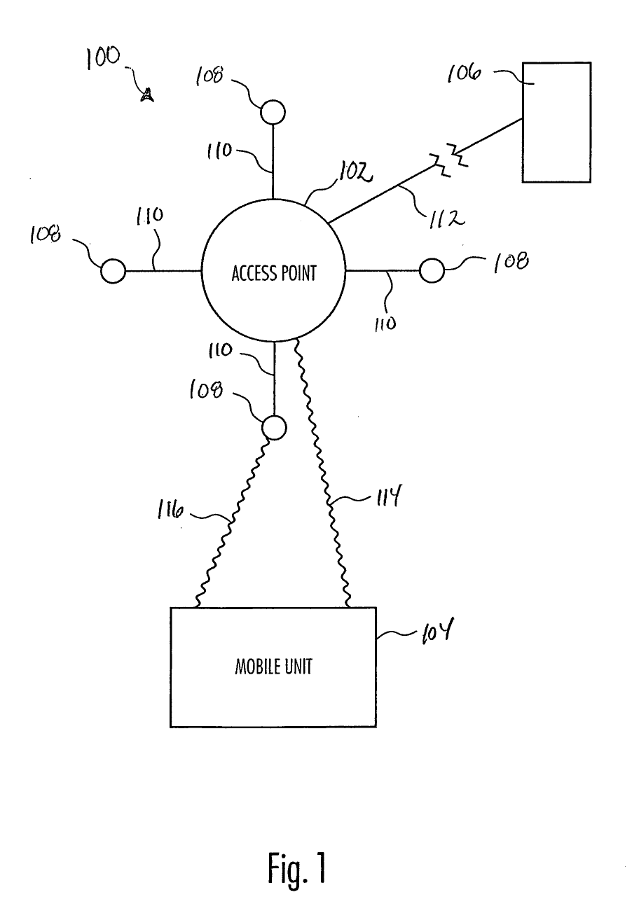

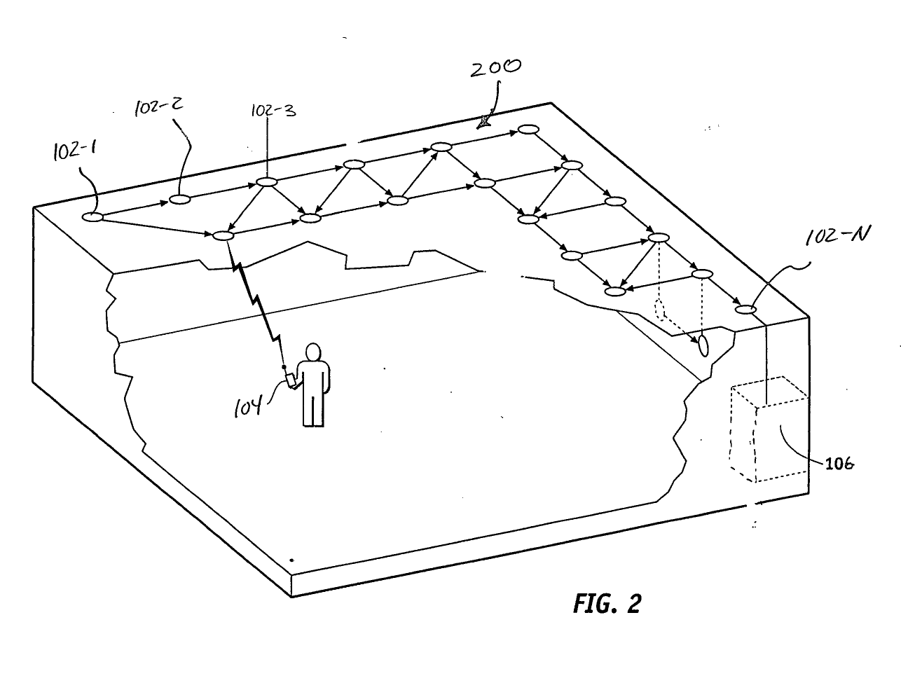

A functional block diagram of an exemplary system 100 according to one embodiment of the present invention is shown in FIG. 1, and includes one or more wireless access points 102, one or more mobile units 104, and one or more server computers 106. Although, for ease of explanation and illustration, only a single access point 102 is shown in FIG. 1, it will be appreciated that the system 100, as shown more clearly in FIG. 2, preferably includes a plurality of distributed access points 102-1, 102-2, 102-3, . . . 102-N configured to intercommunicate with one or more other access points 102-1, 102-2, 102-3, . . . 102-N to thereby implement a WLAN (wireless local area network) 200.

Referring once again to FIG. 1, it is seen that each access point 102 includes one or more RFID antennas 108. In the depicted embodiment, each RFID antenna 108 is coupled to its associated access point 102 via an interconnecting cable 110 such as, for example, a coaxial cable. The length of each interconnecting cable 110 may vary, and allows for the RFID antennas 108, if needed or desired, to be placed remotely from the access point 102. Each access point 102 is additionally coupled to the one or more server computers 106 via a communication link 112. It will be appreciated that each server computer 106 may be a single computer, a computer network, or any one of numerous other devices, or combination of devices, capable of receiving data from, and transmitting data to, each access point 102. It will additionally be appreciated that each server computer 106 may be any one of numerous types of standard computers configured to operate as a network server, or a specially designed, application specific computer. Moreover, it will be appreciated that the communication link 112 between the access point 102 and the server computer 106 may be a wired communication connection, such as an Ethernet connection, or a wireless connection. In a particular preferred embodiment, the communication link 112 is a wireless link.

In a particular preferred embodiment, each access point 102 in the WLAN 200 is configured to serve multiple mobile units 104 in a defined area and, as such, is able to handle all WLAN communications in that defined area. However, an access point 102 can become busy if, for example, one of the mobile units 104 in the defined area requests a large amount of information. Thus, in areas where the coverage area of one access point 102 is, or may be, insufficient, multiple access points 102 are included. When multiple access points 102 are included in a defined area, the access points 102 include protocols that allow the different access points 102 to hand off mobile units 104 between one another, as necessary, as the mobile unit 104 moves about the defined area.

The mobile unit 104 may be any one of numerous devices configured to wirelessly communicate with one or more access points 102 including, for example, a wireless personal computer (PC), a cellular telephone, a beeper, a wireless RFID reader, or a wireless bar code reader. In a particular preferred embodiment, the mobile unit 104 is implemented as a wireless device that is readily transportable from one location to another, either by hand or other device. However, it will be appreciated that the mobile unit 104 could also be implemented as a fixed, non-moveable device configured to wirelessly communicate with one or more of the access points 102. As shown in FIG. 1, this wireless communication may be implemented using either WLAN signals 114 or RFID signals 116. Preferably, the WLAN signals 114 are compliant with one of the IEEE standard 802.xx communication protocols. Moreover, the RFID signals 116, which include both RFID interrogation signals and RFID response signals, are preferably compliant with any one of numerous standard RFID communication protocols, such as those disclosed in The RFID Handbook by Klaus Finkenzeller, which is hereby incorporated by reference. It will be appreciated that both of these communication protocols are merely exemplary of a particular preferred embodiment, and that other communication protocols for either, or both, the WLAN signals 114 and the RFID signals 116 could also be used.

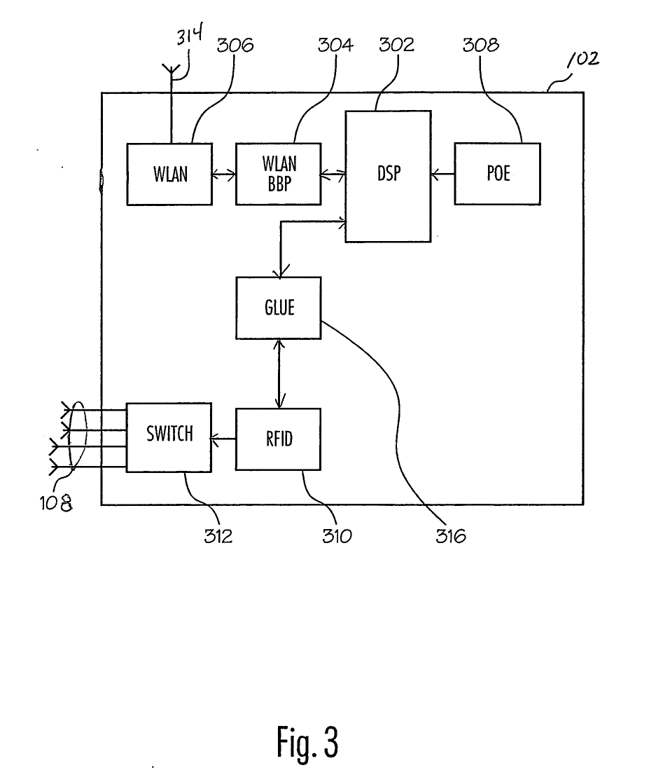

With reference now to FIG. 3, a more detailed description of a particular embodiment of an access point 102 will be provided. It should be appreciated that the depicted and described embodiment is merely exemplary of a particular architecture, and that various other architectures could be used. As shown in FIG. 3, each access point 102, at least in the depicted embodiment, includes a DSP (digital signal processor) 302, a WLAN base-band chip 304, a WLAN transceiver 306, a power over Ethernet (PoE) controller 308, and an RFID transceiver 310. The DSP 302 is coupled to the WLAN base-band chip 304, and the PoE controller 308, and may be any one of numerous processors, including a general purpose microprocessor, configured to receive and manipulate digital data. For example, the DSP 302 may be configured to convert digital data that it receives to a desired transmission protocol for transmission by another circuit or device. In the depicted embodiment, the DSP 302 is configured to receive RFID data from the RFID transceiver 310 and convert the received data to appropriate format for transmission, via the WLAN base-band chip 304 and the WLAN transceiver 306, onto the WLAN 200. The DSP is also preferably configured to receive data from the WLAN 200, via the WLAN base-band chip 304 and WLAN transceiver 306, and to convert the received data to RFID format for transmission via the RFID transceiver 310.

The WLAN base-band chip 304 is coupled between the DSP 302 and the WLAN transceiver 306. The WLAN base-band chip 304, which may be any one of numerous known on-chip circuits configured to perform the hereafter described function, converts received WLAN signals 114 to digital data signals, and digital data signals to appropriate WLAN signals 114. More particularly, the WLAN base-band chip 304 is preferably configured to receive WLAN signals 114 from the WLAN transceiver 306, and to convert these WLAN signals 114 to digital data signals that the DSP 302, as described above, can appropriately manipulate. The WLAN base-band chip 304 is also preferably configured to convert digital data signals generated by the DSP 302 to an appropriate WLAN signal 114 that the WLAN transceiver 306 can then transmit, for example, onto the WLAN 200.

The WLAN transceiver 306 is coupled to one or more WLAN antennas 314, and is configured to receive WLAN signals 114 from, and transmit WLAN signals 114 to, other wireless devices, such as other access points 102, the mobile unit 104, or the server computer 106. The WLAN transceiver 306, as mentioned above, is also configured to supply and receive WLAN signals 114 to and from, respectively, the WLAN base-band chip 304. It will be appreciated that the WLAN transceiver 306 may be any one of numerous types of circuits configured to implement wireless communications. In a particular preferred embodiment, the WLAN transceiver 306 is compliant with wireless communication protocol standards such as, for example, the IEEE 802.XX standards, though it will be appreciated that other wireless communication protocols could be used.

The PoE controller 308, which may be any one of numerous circuits configured to implement IEEE standard 802.3af, receives power and data packets via a wired network connection, and supplies power to the various circuits of the access point 102. It will be appreciated that the use of the PoE controller 308 is merely exemplary of one particular embodiment, and that the access point 102 may be powered via any one of numerous known devices and methods including, for example, one or more batteries, or a wired connection to a power source.

The RFID transceiver 310, which is also colloquially referred to as an “RFID reader,” is coupled to an antenna switch 312, and to the DSP 302 via so-called “Glue Logic” 316. The RFID transceiver 310 is configured to transmit RFID signals 116 to, and to receive RFID signals 116 from, one or more RFID tags (or RFID transponders). More specifically, the RFID transceiver transmits RFID interrogation signals 116 to one or more RFID tags (not shown in FIG. 1), and receives RFID response signals from one or more RFID tags. The RFID transceiver 310 transmits and receives the RFID signals 116 via one or more of the RFID antennas 108. The antenna switch 312 controls the particular antenna to which the RFID transceiver 310 is coupled. Although each access point 102 could be implemented with only a single RFID antenna 108, it will be appreciated that each access point 102, as described above, includes a plurality of RFID antennas 108, since this can increase the coverage of the RFID transceiver 310. More specifically, by switching between each of the RFID antennas 108, different RFID antennas 108 can be used to send an RFID interrogation signal 116 to an RFID tag. If the same RFID interrogation signal 116 is transmitted via three or more RFID antennas 108, the RFID transceiver 310 determines the location of an RFID tag using any one of numerous types of location determination methods. Moreover, as is generally known, the RFID interrogation signals 116 transmitted by the RFID transceiver 310 preferably include an identifier that specifies one or more RFID tags from a plurality of RFID tags.

As was noted above, the RFID transceiver 310 is coupled to the DSP 302 via the Glue Logic 316. As is generally known, Glue Logic 316 is any device configured to interface two or more devices and/or two or more communication protocols. In the depicted embodiment, the Glue Logic 316 interfaces the RFID transceiver 310 and the DSP 302 to allow intercommunication between the WLAN and RFID portions of the access point 102. It will be appreciated that the Glue Logic 316 may be implemented in hardware, software, firmware, or combination thereof.

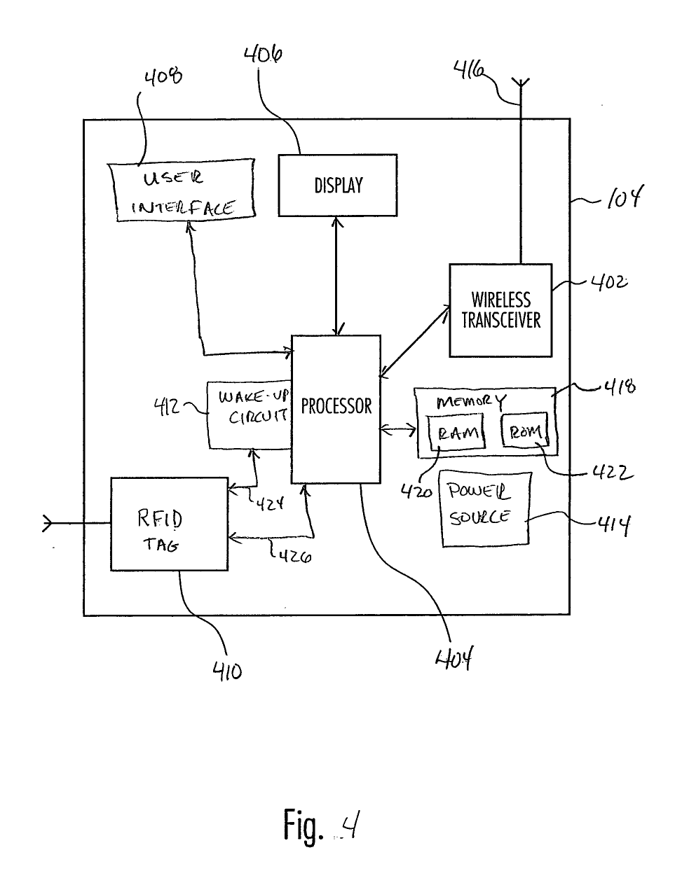

Turning now to FIG. 4, a functional block diagram of an exemplary mobile unit 104 is shown, and will be described in more detail. Before doing so, however, it should be appreciated that the depicted and described embodiment is merely exemplary of a particular general architecture, and that various other architectures could be used. In the depicted embodiment, the mobile unit 104 includes a wireless transceiver 402, a processor 404, a display 406, a user interface 408, an RFID tag 410, a wake-up circuit 412, and a power source 414. The wireless transceiver 402 is coupled to a wireless antenna 416, and is configured to wirelessly receive data from, and transmit data to, one or more access points 102, one or more other mobile units 104, or one or more other non-illustrated wireless devices. The wireless transceiver 402 is preferably compliant with one or more of the IEEE standard 802.xx communication protocols, though it will be appreciated that any one of numerous other wireless communication protocols can be used.

The processor 404 may be any one of numerous known general-purpose microprocessors or an application specific processor that operates in response to program instructions. The processor 404 is in operable communication with one or more memory storage devices 418 (only one shown for convenience), which in the depicted embodiment includes both RAM (random access memory) 420 and ROM (read only memory) 422. It will be appreciated that the memory storage devices 418 could be physically implemented apart from the processor 404, as shown in the depicted embodiment, or the memory storage devices 418 could be partially or fully implemented on the processor 404.

No matter the particular physical implementation of the memory storage devices 418, it will be appreciated that some or all of the program instructions that control the processor 404 are stored in either, or both, the RAM 420 and the ROM 422. For example, operating system software may be stored in the ROM 422, whereas various operating mode software routines and various operational parameters may be fully, or partially, stored in the RAM 420. It will be appreciated that this is merely exemplary of one scheme for storing operating system software and software routines, and that various other storage schemes may be implemented. Indeed, as will be discussed in more detail further below, various software routines may be fully, or partially, stored in memory associated with the RFID tag 410.

The display 406 is used to display various images and data, in either or both a graphical and a textual format, to thereby supply visual feedback of mobile unit operations. It will be appreciated that the display 406 may be any one of numerous known displays suitable for rendering image and/or text data in a viewable format. Non-limiting examples of such displays include various cathode ray tube (CRT) displays, and various flat panel displays such as, for example, various types of LCD (liquid crystal display) and TFT (thin film transistor) displays.

The user interface 408 may be any one, or combination, of various known user interface devices including, but not limited to, a touch sensitive display, a cursor control device, such as a mouse, a trackball, or joystick, and/or a keyboard, one or more buttons, switches, or knobs. No matter the particular implementation, the user interface 408 is configured, among other things, to allow a user to input data to the processor 408.

The RFID tag 410 may be separately coupled to, and interfaced with, the mobile unit 104, or provided as an integral part of the mobile unit 104. In either case, the RFID tag 410 is configured to receive RFID interrogation signals 116 from the RFID transceiver 310 in one or more of the access points 102 and, in response to the RFID interrogation signals 116, to selectively supply one or more RFID response signals 116 and one or more transition signals. As is generally known, the RFID response signals 116 include, among other things, identification data stored in the RFID tag 410. As will be described more fully further below, the identification data is used, among other things, to identify, and to determine the location of, the mobile unit 104.

The transition signals supplied by the RFID tag 410, as will also be described in more detail further below, cause the mobile unit 104 to transition from one operational state to one or more other operational states. For example, in one embodiment, the transition signals include one or more command or interrupt signals that cause the mobile unit 104 to transition from a “sleep mode,” or other low-power idle state, to an “awake mode,” or other a full power-on state. In another embodiment, the transition signals include one or more command or interrupt signals that cause the mobile unit 104 to implement one or more software routines. In yet another embodiment, the transition signals include one or more command or interrupt signals that cause the mobile unit 104 to transition from a “sleep mode,” or other low-power idle state, to a full power-on state, and to implement one or more software routines. Thus, as shown in FIG. 4, the RFID tag supplies the transition signals to either, or both, the wake-up circuit 412 and the processor 404 via first and second communication links 424 and 426, respectively. It will be appreciated that one or both of the first and second communication links 424, 426 could be implemented as either wired or wireless communication links.

The wake-up circuit 412, in one embodiment, is configured to periodically poll the RFID tag 410 to determine whether the RFID tag 410 is transmitting one or more of the above-mentioned transition signals. If the RFID tag 410 is transmitting a transition signal, the wake-up circuit 412 applies power (e.g., from a non-illustrated battery) to the remaining circuits in the mobile unit 104. If the RFID tag 410 is not transmitting a transition signal during the periodic poll, the wake-up circuit 412 leaves the mobile unit 104 in the “sleep mode,” or other low-power idle state. To conserve power, the wake-up circuit 412 is preferably configured to operate at low current even while polling the RFID tag 410. The wake-up circuit 412, as will be appreciated, may be implemented using any one of numerous known wake-up circuit configurations. Moreover, although shown as being implemented as a separate circuit, it will be appreciated that the processor 404 could alternatively implement the wake-up circuit functionality.

The power source 414 is electrically coupled to, and powers, each of the above-described circuits in the mobile unit. For clarity of illustration, the electrical interconnections of the power source 414 are not shown. The power source 414 may be any one of numerous types of power sources, but in a preferred embodiment, the power source 414 is a rechargeable power source such as, for example, one or more rechargeable batteries. In an exemplary embodiment, the power source 414 is charged by connecting the mobile unit 104, or just the power source, to an external power source (not illustrated) for a period of time. Thereafter, once the power source 414 is charged, it can be disconnected from the external power source, and used to supply power for the mobile unit 104.

Referring once again to the RFID tag 410, it will be appreciated that it may be any one of numerous known types of RFID tags, the overall function and structure of which is generally known. Thus, although a description of an exemplary embodiment of the RFID tag 410 is not needed to provide either an enabling or fully descriptive disclosure, such a description will nonetheless be provided. Before doing so, however, a brief overview of RFID tag operational types will be provided. As is generally known, an RFID tag may be implemented as an active tag, a semi-active tag, or a passive tag. An active RFID tag typically includes an on-board power source, such as an internal battery, to transmit data, and typically includes the ability to read and write greater amounts of stored data than either passive or semi-passive tags. A passive RFID tag includes no on-board power source, transmits data by reflecting and absorbing energy from the RFID signals transmitted from an RFID reader (e.g., an RFID transceiver 310), and uses energy absorbed from the RFID signals for data storage, retrieval, and manipulation. A semi-passive tag is somewhat of a hybrid of the active and passive tags. In particular, a semi-passive tag includes an on-board power source, such as an internal battery, to power, for example, volatile memory or an on-board sensor but, similar to a passive tag, transmits data by reflecting and absorbing energy from the RFID reader. In addition, some RFID tags are implemented as multi-mode tags that, among other things, can operate as either a passive tag or a semi-passive tag.

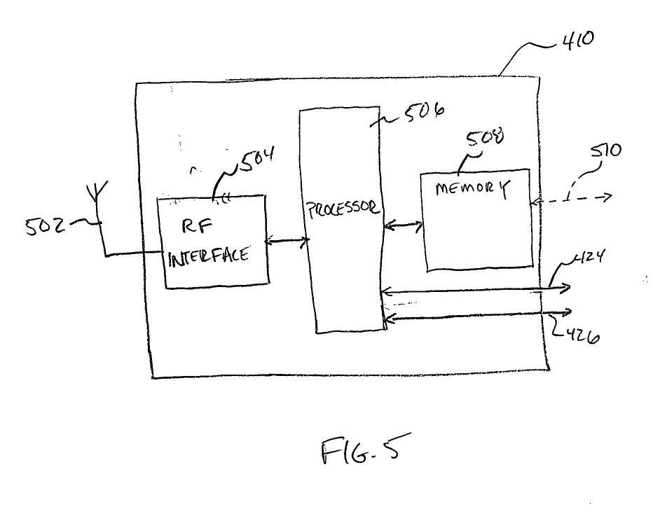

In a particular preferred embodiment, the mobile unit RFID tag 410 is implemented as a passive tag, a semi-passive tag, or a multi-mode tag configured to implement either of these paradigms. It will nonetheless be appreciated that the RFID tag 410 could also be implemented as an active tag, in which case the RFID tag 410 preferably receives its operational power from the mobile unit power source 414. A simplified functional block diagram of an exemplary preferred embodiment of the RFID tag 410 is depicted in FIG. 5, and with reference thereto, will now be described in more detail. The RFID tag 410 includes an RFID tag antenna 502, an RF interface 504, a tag processor 506, and tag memory 508. It will be appreciated that the RFID tag 410 could include various other circuits and components. However, such circuits and components, though potentially useful, are not needed to understand or implement the claimed invention. Thus, these additional components are, for the sake of brevity, neither described nor depicted herein.

The RFID tag antenna 502, which may be any one of numerous known RFID antennas, is coupled to the RF interface 504, which may similarly be implemented using any one of numerous known RFID tag interface circuit configurations. The RFID tag antenna 502 and RF interface 504 are configured to receive RFID interrogation signalsl 16 from, and to emit RFID response signals 116 to, the RFID transceiver 310 in one or more of the access points 102. It will be appreciated that the RF interface 504 may include, for example, one or more storage capacitors to store energy received by the RFID antenna 502, if the RFID tag 410 is not powered by an internal storage battery (e.g., is a passive tag), or is powered by both an internal storage capacitor and a battery (e.g., a semi-passive tag).

The tag processor 506 may be any one of numerous known general-purpose microprocessors or an application specific processor that operates in response to program instructions. In the depicted embodiment, the tag processor 506, among other things, controls the overall operation of the RF interface 504, supplies the transition signals to the wake-up circuit 412 and/or the mobile unit processor 404 via one or more of the above-mentioned communication links 424, 426, and controls data read and write operations from and to, respectively, the tag memory 508. Moreover, if the RFID tag 410 is implemented as a multi-mode type of tag, the tag processor 506 may additionally run a tag emulation selection routine that switches the type of tag paradigm that the RFID tag 410 will emulate (e.g., active, semi-passive, or passive).

The tag memory 508 is in operable communication with the tag processor 506 and stores various types of data. The stored data, as was just alluded to above, may be selectively retrieved by, or supplied from, the tag processor 506. The stored data may include, for example, one or more interrupt flags, complete sets of program instructions, and tag and/or mobile unit identification data. As will be described more fully further below, the interrupt flags and/or program instructions are selectively supplied from the tag memory 508 to the mobile unit processor 404, which in turn causes the mobile unit 104 to initiate one or more software routines. The identification data, as will also be described more fully below, is sent as part of the RFID response signal 116 to the particular access point 102 from whence the corresponding RFID interrogation signal 116 was received. Although depicted as being physically implemented as part of the RFID tag 410, it will be appreciated that the tag memory 508 could be implemented as shared memory. That is, the tag memory 508 could, for example, be in operable communication with the mobile unit processor 404 or other interface circuitry in the mobile unit 104. In such an embodiment, which is shown in phantom in FIG. 5, the mobile unit 104 can directly read data from, and write data to, the tag memory 508 via a wired or wireless communication link 510.

The tag memory 508 is preferably non-volatile memory; however, it will be appreciated that it could be any one of numerous types of memory or memory subsystems including, for example, a collection or combination of read-write volatile memory, read only non-volatile, read/write non-volatile. It will additionally be appreciated that the tag memory 508 may be physically implemented in any one of numerous known configurations including, for example, flash memory, EEPROM, ferro-electric random access memory (FRAM), magneto-resistive RAM/ROM, magnetic RAM/ROM, one or more magnetic storage devices, or one or more optical storage devices.

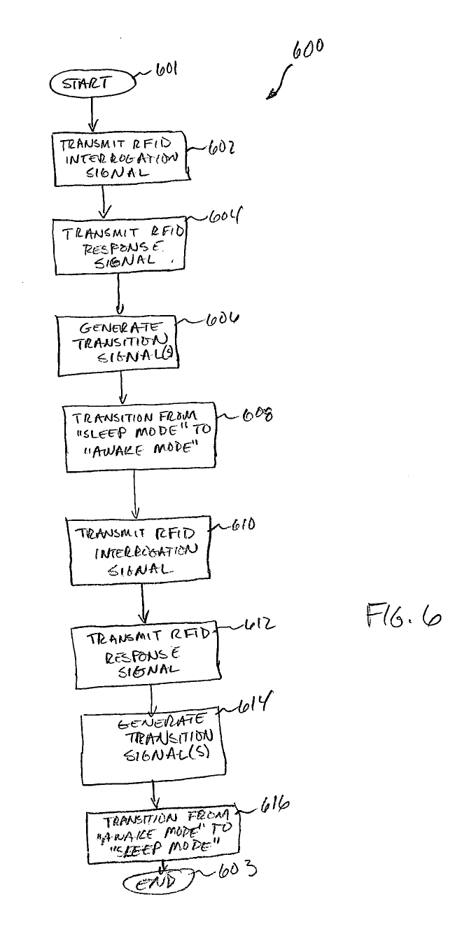

The system and devices described above function together to provide RFID-based methods of, among other things, power management, selective application launching on power-up, location-based application launching, and secure device operation and control, for various types of wireless mobile units 104. These RFID-based methods, it will be appreciated, may be implemented alone or in various combinations with one another. Particular embodiments of each of these overall methods are individually depicted in flowchart form in FIGS. 6-8, and will now be described in more detail. In doing so, reference should be made, as appropriate, to FIGS. 6-8, in combination with FIGS. 1-5. Moreover, it will be appreciated that the parenthetical references in the following description refer to like reference numerals in the flowcharts.

Turning now to FIG. 6, an RFID-based power management process 600 for one or more mobile units 104 will first be described. This description is predicated on the WLAN 200 wanting to initiate communication with a mobile unit 104 that is in the above-described “sleep-mode.” In accordance with the depicted process 600, when the WLAN 200 wants to communicate with a particular mobile unit 104, the server computer 112 commands one or more of the access points 102 to transmit an RFID interrogation signal 116 (602). The RFID interrogation signal 116, as was noted above, includes an identifier that specifies the RFID tag 410 associated with the particular mobile unit 104 with which the WLAN 200 wants to communicate. Thus, only that specific RFID tag 410 is placed into a responsive mode, while other RFID tags remain muted to at least the particular RFID interrogation signal 116 sent to the specific RFID tag 410.

When the specified RFID tag 410 receives the RFID interrogation signal 116, it is put into a responsive mode, and transmits an appropriate RFID response signal 116 back to the access point 102 (604). In a preferred embodiment, in which the RFID tag 410 is a passive or semi-passive tag, the RFID response signal 116 is transmitted by modulating a back scattered signal. The RFID response signal 116, as described above, includes data, stored in the RFID tag memory 520, which identifies either, or both, the RFID tag 410 or the associated mobile unit 104. Thus, the access point 102 will be able to determine that the RFID interrogation signal 116 it sent was indeed received by the proper RFID tag 410.

In addition to transmitting the RFID response signal 116, the RFID tag 410 also generates one or more transition signals in response to the RFID interrogation signal 116 (606). In the depicted embodiment, the transition signals cause the mobile unit 104 to transition from the “sleep mode” to the “awake mode” (608). As was noted above, the wake-up circuit 412 in the mobile unit 104 may be physically implemented in any one of numerous ways. Thus, as was also previously noted, the wake-up transition signals may be generated in any one of various forms such as, for example, one or more commands or interrupt signals. No matter the particular manner in which the wake-up circuit 412 is physically implemented, or the particular form in which the wake-up transition signal is generated, once the mobile unit 104 is fully-powered up, it can then begin communicating with the WLAN 200.

Thereafter, when the WLAN 200 no longer wants to communicate with the mobile unit 104, one of the access points 102 transmits an additional RFID interrogation signal 116 to the mobile unit RFID tag 410 (610). Upon receipt of the RFID interrogation signal 116, the RFID tag 410 is again put into a responsive mode, and once again transmits an appropriate RFID response signal 116 (612) and generates one or more transition signals (614). In this instance, however, the transition signals cause the mobile unit 104 to transition from the “awake mode” back to the “sleep mode” (616). Thus, energy is not unnecessarily depleted from mobile unit power source 414, thereby conserving power and reducing the frequency of re-charge cycles. Although not depicted in FIG. 6, it will be appreciated that in addition to, or instead of, transitioning back to to the “sleep mode” in response to an RFID interrogation signal 116, the mobile unit 104 could be further configured to transition back to the “sleep mode” if it has not communicated with the WLAN 200 for some predetermined time period.

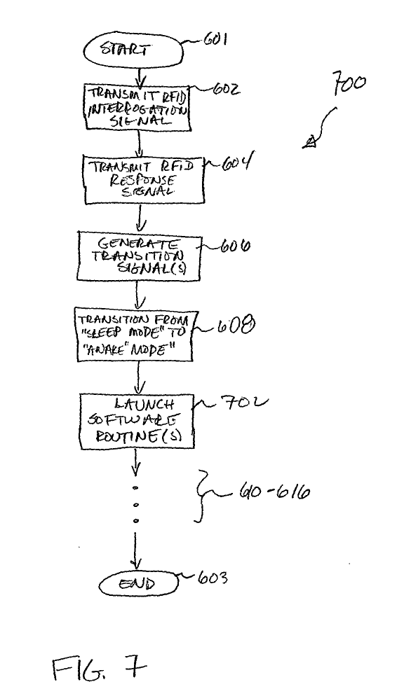

In addition to implementing a power management process, such as the process 600 described above, the system 100 can implement a process in which the mobile unit 104, upon transitioning to the “awake mode,” will also selectively launch one or more software routines. An embodiment of such a process 700 is shown in FIG. 7, and includes several process steps that are substantially identical to process steps in the previously described power management process 600. These steps are identified with like reference numerals and, for brevity, will therefore not be once again described.

Turning now to FIG. 7, once the RFID interrogation signal 116 is transmitted and received, and the RFID response signal 116 is transmitted (602-604), the RFID tag 410 generates the transition signals (606). In the depicted embodiment, the transition signals supplied to the mobile unit 104 cause the mobile unit 104 to not only transition from the “sleep mode” to the “awake mode” (608)” but to also launch one or more specific software routines (702). The specific software routines the mobile unit 104 launches may be the same each time it transitions from the “sleep mode” to the “awake mode”. Alternatively, or in addition to this, the transition signals may include one or more commands or interrupts that specify particular software routines that the mobile unit 104 should launch. It will be appreciated that the commands or interrupts may point the mobile unit processor 404 to a particular set, or subset, of program instructions stored in the mobile unit RAM 420 or ROM 422, or stored in the RFID tag memory 508. Alternatively, the commands or interrupts may include a set, or subset, of program instructions for implementation by the mobile unit processor 404.

Although the above-described process 700 is depicted and described as also implementing the previously-described power management process 600, it will be appreciated that the process 700 can also be implemented apart from the power management process 600. Indeed, in such an embodiment, any time the mobile unit 104 is in the “awake mode,” the mobile unit 104 may be configured to receive one or more additional transition signals from the RFID tag 410 that cause the mobile unit 104 to launch one or more specific software routines.

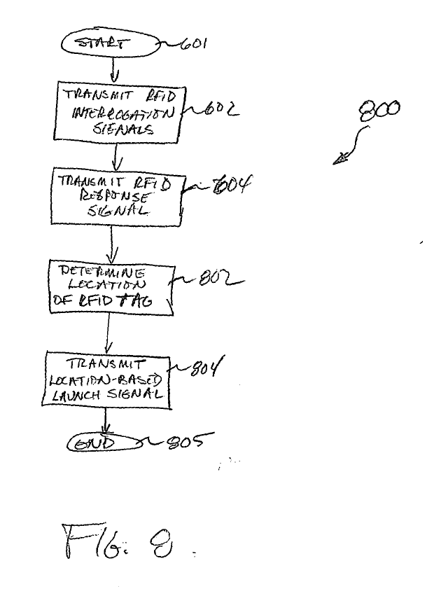

The above-described processes 600 and 700 may be further enhanced to additionally, or instead, include location-based application launching capabilities. In particular, the system 100 can implement a process 800, an exemplary embodiment of which is shown in FIG. 8, in which the mobile unit 104 is commanded to launch one or more software routines, based at least in part on its location. Although this process 800 is shown and described as being implemented apart from the power management process 600, it will be appreciated that it could be implemented as part of the power management process 600. In either case, it is seen that the depicted process 800 includes various process steps that are substantially identical to process steps in the power management process 600. As before, these steps are identified with like reference numerals and, for brevity, are not further described.

As shown in FIG. 8, after the RFID interrogation signal 116 is transmitted and received, and the RFID response signal 116 is transmitted (602-604), the access point 102 uses the RFID response signal to determine the location of the mobile unit 104 (802). As is generally known, the access point 102 can, using various real-time location determination techniques, determine the physical location of the RFID tag 410 with relatively high accuracy. Such techniques include, for example, phase difference of arrival (PDOA), or any one of numerous other triangulation techniques that use location data from three or more access points. In a particular preferred embodiment, the access point 102 implements the PDOA location determination technique. A particular preferred embodiment of the PDOA technique is disclosed in U.S. patent application Ser. No. 10/748,453, entitled “Object Location System and Method Using RFID,” which is assigned to the Assignee of the present application, the entirety of which is hereby incorporated by reference.

Once the access point 102 determines the location of the mobile unit 104 (802), it then transmits a location-based launch signal that causes the mobile unit 104 to launch one or more specific software routines (804). The access point 102 may transmit the location-based launch signal in any one of numerous ways. For example, the location-based launch signal may be transmitted as either, or both, a WLAN signal 114 or an RFID signal 116. If the location-based launch signal is a WLAN signal 114, then the signal 114 is received directly by the mobile unit 104, which appropriately processes the signal 114 and determines the particular routine(s) to launch. Conversely, if the location-based launch signal is an RFID signal 116, then the signal 116 is received by the RFID tag 410, which appropriately processes the signal 116 and determines the particular routine to launch. This determination is then communicated to the mobile unit 104. If the location-based launch signal is a combination of a WLAN 114 and an RFID signal 116, then the access point 102 may transmit data, such as a particular flag, command, or interrupt routine, to the RFID tag 410 for storage in a particular location in the RFID tag memory 508, and a command to the mobile unit 104 that instructs the mobile unit 104 to access and retrieve the data transmitted and stored in the particular location in the RFID tag memory 508. The mobile unit 104 will then launch a specific software routine based on the retrieved data. In a particular preferred embodiment, the location-based launch signal is an RFID signal 116 that either includes, or sets, a particular flag in the RFID tag memory 508. The mobile unit 104 then launches a particular software routine based on that particular flag.

It will be appreciated that the location-based application launching process 800 described above provides not only a convenient method by which a mobile unit 104 can be powered up and/or configured upon being positioned at or near a particular location, but the process 800 can also be used for security purposes. For example, the system 100, 200 can be configured to prevent the mobile unit 104 from transitioning from the “sleep mode” to the “awake mode,” based on the location of the mobile unit 104. Alternatively, the system 100, 200 can be configured to prevent the mobile unit 104 from launching one or more specific software routines, or from communicating with the WLAN 200, based on the location of the mobile unit 104. Such a capability (or capabilities) prevents a mobile unit 104 from communicating with the WLAN 200 if it is located outside a particular area, and/or not positioned at a particular location.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A wireless device, comprising:
an RFID tag configured to receive an RFID interrogation signal and, upon receipt thereof, to supply one or more transition signals; and
a wake-up circuit coupled to receive the transition signals and configured, upon receipt thereof, to transition the wireless device from a first operational state to a second operational state.

2. The device of claim 1, further comprising:
a processor coupled to receive the transition signals and configured, upon receipt thereof, to run one or more software routines.

3. The device of claim 2, wherein the software routines the processor runs are based at least in part on content of the transition signals.

4. The device of claim 2, wherein the software routines the processor runs are based at least in part on a location of the wireless device.

5. The device of claim 2, further comprising:
memory in operable communication with the processor,
wherein at least a portion of the program instructions are stored in the memory.

6. The device of claim 2, further comprising:
a wireless transceiver configured to wirelessly communicate with one or more network communication nodes,
wherein the software routines the processor runs are based at least in part on communications from the one or more network communication nodes.

7. The device of claim 1, further comprising:
a wireless transceiver configured to wirelessly communicate with one or more network communication nodes.

8. The device of claim 1, wherein the RFID tag is a passive tag.

9. The device of claim 1, wherein the RFID tag is a semi-passive tag.

10. The device of claim 1, wherein the RFID tag is an active tag.

11. The device of claim 1, further comprising:
a power source coupled to the wake-up circuit and configured to supply electrical power thereto.

12. The device of claim 11, wherein power source is further configured to supply electrical power to other portions of the wireless device during, and upon, its transition to the operational state.

13. The device of claim 1, wherein:
the first operational state is a reduced-power operational state; and
the second operational stat is a full-power operational state.

14. A wireless communication system, comprising:
an RFID tag configured to receive an RFID interrogation signal and, upon receipt thereof, to supply one or more transition signal; and
a wireless communication device configured to operate in a plurality of operational states, the device coupled to receive the transition signals and configured, upon receipt thereof, to transition from at least a first operational state to a second operational state.

15. The system of claim 14, wherein the wireless communication device is further configured, upon receipt of the transition signals, to run one or more software routines.

16. The system of claim 15, wherein the software routines are based at least in part on content of the transition signals.

17. The system of claim 14, wherein the software routines are based at least in part on a location of the RFID tag.

18. The system of claim 14, wherein:
the RFID tag includes memory having data stored therein; and
the software routines are based at least in part on the data stored in the RFID tag memory.

19. The system of claim 15, wherein the wireless communication device is further configured to wirelessly communicate with one or more network communication nodes

20. The system of claim 19, wherein the software routines are based at least in part on communications the wireless communication device receives from the one or more network communication nodes.

20. The system of claim 14, wherein the RFID tag is a passive tag.

21. The system of claim 14, wherein the RFID tag is a semi-passive tag.

22. The system of claim 14, wherein the RFID tag is an active tag.

23. The system of claim 14, wherein:
the transition signals include a wake-up signal;
the first operational state is reduced-power operational state; and
the second operational state is a full-power operational state.

24. A system for controlling the operational state of a wireless device, comprising:
an RFID transceiver configured to transmit an RFID interrogation signal; and
an RFID tag configured to receive the RFID interrogation signal and, in response thereto, to transmit one or more transition signals that, upon receipt thereof by the wireless device, transitions the wireless device from a first operational state to a second operational state.

25. The system of claim 24, wherein the RFID tag comprises:
memory having data stored therein that is selectively readable by the wireless device.

26. The system of claim 25, wherein the stored data includes one or more interrupt flags.

27. The system of claim 25, wherein the stored data includes complete instructions for running one or more software routines on the wireless device.

28. The system of claim 24, further comprising:
a wireless network in operable communication with the RFID reader.

29. The system of claim 24, wherein:
the transition signals include a wake-up signal;
the first operational state is a reduced-power operational state; and
the second operational state is a full-power operational state.

30. A method of managing the operation of a wireless communication device having an RFID tag in operable communication therewith, the method comprising the steps of:
transmitting an RFID interrogation signal to the RFID tag; and
upon receipt of the RFID interrogation signal, transitioning the wireless communication device from a first operational state to a second operation state.

31. The method of claim 30, further comprising:
determining a location of the RFID tag; and
transitioning the wireless communication device from the first operational state to the second operational state based at least in part on the determined RFID tag location.

32. The method of claim 31, further comprising:
preventing the wireless communication device from transitioning from the first operational state to the second operational state if the determined RFID tag location is at least proximate a predetermined location.

33. The method of claim 30, wherein:
the first operational state is a reduced-power operational state; and
the second operational state is a full-power operational state.
